(19) United States
(12) Patent Application Publication
(10) Pub. No.: US 2009/0140987 A1
(43) Pub. Date: Jun. 4, 2009

(54) DUPLEX TOUCH PANEL

(76) Inventor: Kai-Ti Yang, Taoyuan (TW)

Correspondence Address: Kai-Ti Yang, Box 8-24, 235 Chung - Ho, Taipei, 235, TW

(21) Appl. No.: 11/949,783

(22) Filed: Dec. 4, 2007

(51) Int. Cl. G06F 3/041

(52) U.S. Cl. 345/173

(57) ABSTRACT

A duplex touch panel comprising: a capacitive touch panel unit; a resistive touch panel unit which is overlapped to the capacitive touch panel unit to be formed as a plate body; a signal processing unit received sensing signals from the capacitive touch panel unit and resistive touch panel unit; a surface layer; a first axis sensing layer being a transparent film; the first axis sensing layer having a plurality of first axis sensing traces; an insulation layer being a transparent insulated film layer; a second axis sensing layer being a transparent film; a base substrate being a flexible highly transparent insulated film; and a first signal output wire bank having a plurality of conductive paths; wherein the first axis sensing traces and second axis sensing traces being arranged along different vertical directions so as to form as a matrix.

### FIELD OF THE INVENTION

The present invention relates to touch panels, and particularly to a duplex touch panel which combines a resistive touch panel unit with a capacitive touch panel unit as a plate body so that the duplex touch panel has the advantages of the two kinds of touch panels, in which the defects of the two kinds of touch panels are removed. The plate body has a uniform transparency and the distortion in the display screen of the touch panel is improved.

### BACKGROUND OF THE INVENTION

The touch panels are widely used in various electronic devices. In general, the touch panels can be divided into three kinds, one is capacitive touch panels, another is resistive touch panels and the other is electromagnetic touch panels. Every kind of panel has its advantages and thus they are used in different fields, for example the resistive touch panels are used in personal digital assistants (PDAs), electronic dictionaries, handsets, MP3s, digital players, or global positioning systems (GPSs), or other small size electronic devices. The capacitive touch panels are mainly used in the notebooks, or virtual touch keyboards, etc.

The resistive touch panel has two sheets of transparent conductive films which are separated with a gap therebetween. The upper conductive film is installed on a surface of a transparent thin film and the lower conductive film is installed on a surface of a hard transparent glass substrate. The two conductive films are tightly sealed within a plate like structure. The upper conductive film and lower conductive film are transparent and thus is suitable to be installed upon a display screen so that the user can input upon the touch panel which is directly corresponding to a position of the screen. The resistive touch panel can be inputted by a pen tip precisely and is suitable for small area input with higher precision, such as input of textures with complex strokes. However the operation of the resistive touch panel is performed by pressure upon the panel, and thus for a long time, the panel will deform or even is destroyed by the repeatedly operation. As a result, the lifetime of the resistive touch panel is finite. Thereby if it is inputted by fingers or other tools with greater input ends, the precision is reduced greatly.

Moreover, the capacitive touch panel includes an X axis sensing layer (X trace) and a Y axis sensing layer (Y trace). The X axis sensing layer and Y axis sensing layer are isolatedly installed in a touch plate. The X axis sensing layer and Y axis sensing layer are grounded individually and are connected to a control circuit. In operation, when a finger touches upon a surface of the touch panel, a capacitive effect will generate. A control circuit will assure the touch position of the finger or conductor by the variation of the capacitor. The capacitive touch panel can be inputted by fingers so that it is convenient in operation. Moreover, in data input operation, no pressure is applied and thus no over larger stress is applied to the touch panel and thus the panel will not deform. Further, the capacitive touch panel is made of less components with a simple structure. The yield ratio is high and it is suitable for mass production. Furthermore, the touch panel can sense the input operations in multiple points. That is, it is suitable for multiplex operation and is also suitable for high level operation, such as electronic games, which makes the operation objects being more active and vivid. However this kind of capacitive touch panel still has many defects necessary to be improved. For example, the capacitive touch panel is easily interfered by electromagnetic waves so as to induce noises and thus the input signals will be adjudged incorrectly, even the fault operation is induced. Besides, the sensitivity of the finger input is low, particular to the input of texture, such as Chinese characters. Although dedicated pens are designed for improving above mentioned defects, it is still not suitable for being used in a small area touch panel with higher precision. Furthermore, the use of dedicated pen is also inconvenient in many fields, for example the pen is not carried out or the pen is lost. Furthermore, the dedicate sensing pen is not inconvenient in many situations. For example when the user do not carry the pen or the pen is lost. Recently, the capacitive touch panel unit is made of PET or other transparent material as a substrate which is used with low impedance conductive material (such as silver glue) as a sensing layer so as to form a transparent capacitive touch panel unit so that it is suitable to be arranged in front of a electronic display screen for inputting by users. However in this prior art, the silver glue is not complete transparent. Furthermore, the sensing layer thereof is formed as latticed traces. As a result, the traces and non-trances in sensing layer (i. e., hollowed portion) have different transparency. Thus, light from the screen experience different diffraction so as to cause that the image is blurred or distort.

Therefore, from above description, it is known that the capacitive touch panel and resistive touch panel unit have their intrinsic defects which are necessary to be improved.

### SUMMARY OF THE INVENTION

Accordingly, the primary object of the present invention is to provide a duplex touch panel which combines a resistive touch panel unit with a capacitive touch panel unit as a plate body so that the duplex touch panel has the advantages of the two kinds of touch panels, in which the defects of the two kinds of touch panels are removed. The plate body has a uniform transparency and the distortion in the display screen of the touch panel is improved.

To achieve above objects, the present invention provides a duplex touch panel comprising: a capacitive touch panel unit; a resistive touch panel unit which is overlapped to the capacitive touch panel unit to be formed as a plate body; a signal processing unit received sensing signals from the capacitive touch panel unit and resistive touch panel unit; where the sensing signals are form touch operation to the touch panel; the signal processing unit having at least one signal determination loop for determining that the sensing signals are from the capacitive touch panel unit or the resistive touch panel unit so as to determine a predetermined signal processing mode and thus performed a predetermined signal processing operation; a surface layer being a flexible highly transparent insulated thin film; a first axis sensing layer being a transparent film with good conductivity; the first axis sensing layer having a plurality of first axis sensing traces which are parallel; and ends of each trace having respective joints; an insulation layer being a transparent insulated film layer; a second axis sensing layer being a transparent film with good conductivity; the second axis sensing layer having a plurality of second axis sensing traces which are parallel; and ends of each trace having respective joints; a base substrate being a flexible highly transparent insulated film; and a first signal output wire bank having a plurality of conductive paths; wherein the panel, the first axis sensing layer, the second axis sensing layer, the base substrate and the first signal output wire bank are glued together sequentially as a transparent plate like body; the first axis sensing traces and second axis sensing traces are arranged along different vertical directions so as to form as a matrix; the joints of the first axis sensing layer and second axis sensing layer are connected to silver conductive wires at edges of the base substrates and are connected to the first signal output wire bank so that signals from the first axis sensing layer and second axis sensing layer are transferred to a signal processing unit through the first signal output wire bank.

The resistive touch panel unit is installed below the capacitive touch panel unit as a plate body. The capacitive touch panel unit is installed below the resistive touch panel unit as a plate body. The first axis sensing layer and the second sensing layer are made of indium tin oxide. The first axis line traces and the second axis line traces have widths between 0.05 and 5 mm. Nodes at connections of the first axis line traces and the second line traces are formed with enlarged sensing areas.

The various objects and advantages of the present invention will be more readily understood from the following detailed description when read in conjunction with the appended drawing.

### BRIEF DESCRIPTION OF THE DRAWINGS

FIG. 1 is a structural cross sectional view of the present invention.

FIG. 2 is a schematic view showing the sensing layers of the capacitive touch panel unit of the present invention.

FIG. 3 is an exploded view of the resistive touch panel unit of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

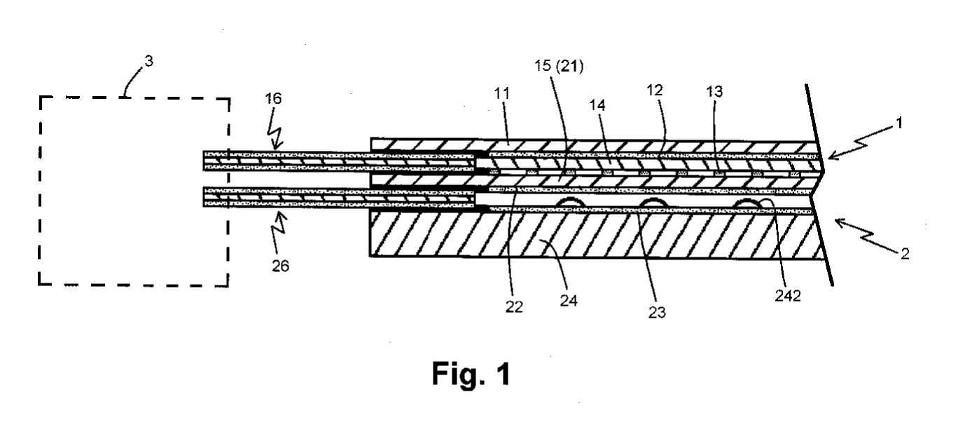

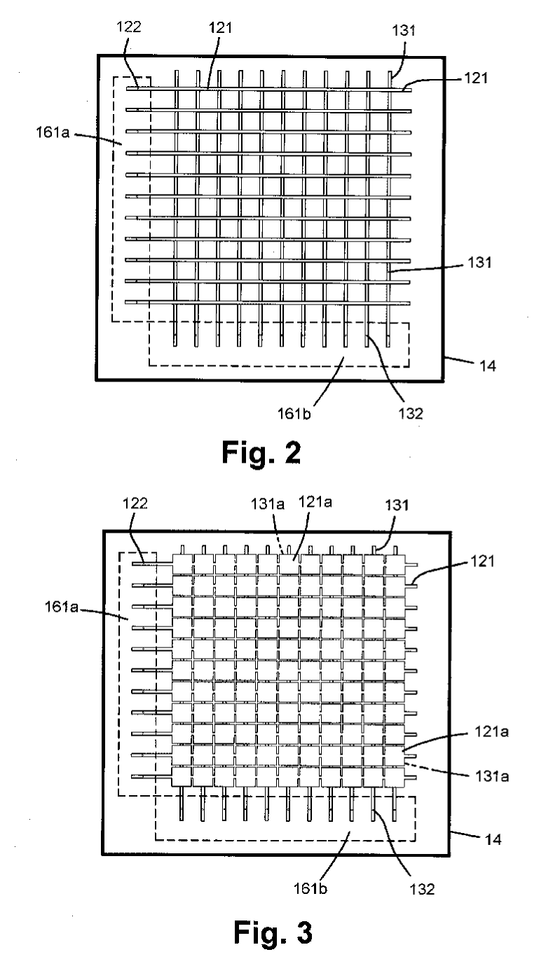

Referring to FIGS. 1 to 3, the preferred embodiment of the present invention is illustrated. The present invention has the following elements. A capacitive touch panel unit 1 has a surface layer 11, an X axis sensing layer 12, a Y axis sensing layer 13, an insulation layer 14 installed between the X axis sensing layer 12 and Y axis sensing layer 13, a base substrate 15 and a first signal output wire bank 16. The surface layer 11 and the bottom layer 15 are high light transmission insulating films, such as glass, Polycarbonate (PC), Polythylene terephthalate (PET), polymethylmethacrylate (PMMA), or Cyclic Olefin Copolymer. A surface of the surface layer 11 is coated with a layer of hard coat, such as a coat of high hardness ultraviolet hardened paint so as to increase the anti-crack and anti-dust abilities on the surface. The material of X axis sensing layer 12 and Y axis sensing layer 13 may be selected from a transparent film with good conductivity, such as material of indium tin oxide (ITO) film. The material of the insulation layer 14 connected the X axis sensing layer 12 and Y axis sensing layer 13 is selected from transparent insulating film material with a dielectric coefficient between 2 to 4, such as oily ink or high transparency polyester films. The material of the first signal output wire bank 16 is selected from flexible printed circuit (FPC) boards. A plurality of conductive wires are arranged on the first signal output wire bank 16. All above mentioned layers can be glued together as a transparent body. Referring to FIGS. 1 and 2, the X axis sensing layer 12 has a plurality of X line traces 121 with a width between 0.05 and 5 mm and the Y axis sensing layer 13 has a plurality of Y line traces 131 with a width between 0.05 and 5 mm. The X directional line traces 121 are vertical to the Y directional line traces 131. One end of the X transparent line trace has an X joint 122 and one end of the Y transparent line trace 131 has a Y joint 132. All the X joints 122 are between to an X silver conductor 161a and all the Y joints 132 are connected to a Y silver conductor 161b. The signals of the X axis sensing layer 12 and Y axis sensing layer 13 are transferred to the first signal output wire bank 16 and then to a signal processing unit 3. In above mentioned structure, an equivalent capacitor is formed between the X axis sensing layer 12 and the X silver conductor 161a and an equivalent capacitor is formed between the Y axis sensing layer 13 and the Y silver conductor 161b. Then a finger touches through a surface of a touch panel. By the variation of capacitor, the signal processing circuit will determine the touch position of the finger from the variation of capacitor. The X line traces 121 and Y line traces 131 are vertical to one another as a lattice and have small widths. Thus, the arrangement is in order. Therefore, the whole touch plate has a uniform transparency. The screen of the touch panel will not distort. Moreover, referring to FIG. 3, the connections of the X line traces 121 and Y line traces 131 can be formed with enlarged sensing surfaces 121a, 131a for reducing the non-line trace area in the touch panel. Thereby the display screen of the touch panel has a uniform transparency and the image distortion in the touch panel is reduced so that the sensitivity and precision of the touch panel is increased.

A resistive touch panel unit 2 has a top plate 21, an upper conductive film 22, a lower conductive film 23, a substrate 24, and a second signal output wire bank 26. In this embodiment, the material of the top plate 21 is the same as that of the base substrate 15 of the capacitive touch panel unit 1. However some other material can be used, in that the material of the top plate 21 is different from that of the resistive touch panel unit 2. When the capacitive touch panel unit 1 is overlapped with the resistive touch panel unit 2 as a plate body, the top plate 21 is glued with the base substrate 15. The substrate 24 is made of hard plate, such as transparent glass plates, acryl plates, or polyester plates. The material of the second signal output wire bank 26 is selected from flexible printed circuit boards and a plurality of conductive wires are arranged on the second signal output wire bank 26. The upper conductive film 22 is an indium tin oxide thin film with a plurality of electric nodes thereon and is installed on an upper surface of the substrate 24. Besides, a plurality of spacing balls 242 are arranged between the upper conductive film 22 and the lower conductive film 23 so as to have a gap therebetween. The peripheries of the upper conductive film 22 and lower conductive film 23 are arranged with insulated gluing layers for combining the two as a transparent plate body. Moreover, the signals of two conductive films are transferred to the second signal output wire bank 26 through the silver conductive circuits 244 on the edges of the two conductive films and then are sent to the signal processing unit 3. Since the capacitive touch panel unit 1 is very thin, when it is installed on the resistive touch panel unit 2, it will not reduce the sensitivity of the resistive touch panel unit 2, while it can buffer the impact from the stress of the indium tin oxide of the upper conductive film 22 so as to avoid the destroy on the edges of two units and prolong the lifetime of the structure.

The signal processing unit 3 has a signal determined loop for determining the sensing signals from the capacitive touch panel unit 1 and/or the resistive touch panel unit 2 so as to select a proper signal processing mode automatically for further signal processing. For example, when the user inputs through the duplex touch panel of the present invention, the touch from the finger will generate capacitive sensing signals on the X axis sensing layer 12 and Y axis sensing layer 13 of the capacitive touch panel unit 1. Because no stress from the finger is applied to the panel, the resistive touch panel unit 2 generates no signal. As a result, when the signals from the capacitive touch panel unit 1 passes through the first signal output wire bank 16 to the signal processing unit 3, the signal determining loop of the signal processing unit 3 determines to use the capacitive sensing signal mode to process the signals. In this mode, the signal processing unit 3 only accepts the sensing signals from the capacitive touch panel unit 1 and the signals from the resistive touch panel unit 2 will not isolate. Further, in case of the resistive sensing signal processing mode, the pen tip will touch a working area of the surface layer 11 for inputting. Because the capacitive touch control panel 1 at an upper side thereof is thin and formed by a flexible material, the pressure from the pen tip will easily transfer through the capacitive touch panel unit 1 to the resistive touch panel unit 2. When the upper conductive film 22 and lower conductive film 23 are conductive due to the pressure from the pen tip, a sensing signal generates. Further the slide or touch of the pen tip will generate no capacitive sensing signal, and thus the capacitive touch panel unit 1 will generates no signal. As a result, when the sensing signal of the resistive touch panel unit 2 is sent to the signal processing unit 3 through the second signal output wire bank 26, the signal processing unit 3 will use a resistive sensing signal processing mode for operation. Under this mode, the signal processing unit 3 only receives and processes the sensing signal from the resistive touch panel unit 2, while the signals from the capacitive touch panel unit 1 will not be accepted.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A duplex touch panel comprising:
a capacitive touch panel unit;
a resistive touch panel unit which is overlapped to the capacitive touch panel unit to be formed as a plate body;
a signal processing unit received sensing signals from the capacitive touch panel unit and the resistive touch panel unit; where the sensing signals are inputted form a touch operation on the touch panel; the signal processing unit having at least one signal determination loop for determining that the sensing signals are from the capacitive touch panel unit or the resistive touch panel unit so as to determine a predetermined signal processing mode and thus performed a predetermined signal processing operation;
a surface layer being a flexible highly transparent insulated thin film;
a first axis sensing layer being a transparent film with good conductivity; the first axis sensing layer having a plurality of first axis sensing traces which are parallel; and ends of each trace having respective joints;
an insulation layer being a transparent insulated film layer;
a second axis sensing layer being a transparent film with good conductivity; the second axis sensing layer having a plurality of second axis sensing traces which are parallel; and ends of each trace having respective joints;
a base substrate being a flexible highly transparent insulated film; and
a first signal output wire bank having a plurality of conductive paths;
wherein the panel, the first axis sensing layer, the second axis sensing layer, the base substrate and the first signal output wire bank are glued together sequentially as a transparent plate like body; the first axis sensing traces and second axis sensing traces are arranged along different vertical directions so as to form as a matrix; the joints of the first axis sensing layer and second axis sensing layer are connected to silver conductive wires at edges of the base substrates and are connected to the first signal output wire bank so that signals from the first axis sensing layer and second axis sensing layer are transferred to a signal processing unit through the first signal output wire bank.

2. The duplex touch panel as claimed in claim 1, wherein the resistive touch panel unit is installed below the capacitive touch panel unit as a plate body.

3. The duplex touch panel as claimed in claim 1, wherein the capacitive touch panel unit is installed below the resistive touch panel unit as a plate body.

4. The duplex touch panel as claimed in claim 1, wherein the first axis sensing layer and the second sensing layer are made of indium tin oxide.

5. The duplex touch panel as claimed in claim 1, wherein the first axis line traces and the second axis line traces have widths between 0.05 and 5 mm.

6. The duplex touch panel as claimed in claim 1, wherein nodes at connections of the first axis line traces and the second line traces are formed with enlarged sensing areas.
